(19) United States
(12) Patent Application Publication
(10) Pub. No.: US 2013/0236161 A1
(43) Pub. Date: Sep. 12, 2013

(54) IMAGE PROCESSING DEVICE AND IMAGE PROCESSING METHOD

(71) Applicant: PANASONIC CORPORATION, Osaka (JP)

(72) Inventor: Shinya TAKEDA, Osaka (JP)

(73) Assignee: PANASONIC CORPORATION, Osaka (JP)

(21) Appl. No.: 13/784,608

(22) Filed: Mar. 4, 2013

(30) Foreign Application Priority Data
Mar. 9, 2012 (JP) 2012052670

(51) Int. Cl. H04N 5/91

(52) U.S. Cl. CPC H04N 5/91
USPC 386/278

(57) ABSTRACT

An image processing device includes a processor that: (i) acquires video data including a plurality of frames, and characteristic information indicating a characteristic value of an image in each of the frames; (ii) receives designation of a correction-target frame which is one of the frames; (iii) identifies, as a correction section, a section to which a frame group belongs, based on the characteristic information, the frame group being made up of consecutive frames including the correction-target frame; and (iv) applies correction designated by a user to the frame group which belongs to the identified correction section.

### CROSS REFERENCE TO RELATED APPLICATION

The present application is based on and claims priority of Japanese Patent Application No. 2012-052670 filed on Mar. 9, 2012. The entire disclosure of the above-identified application, including the specification, drawings and claims is incorporated herein by reference in its entirety.

### FIELD

The present disclosure relates to an image processing device capable of editing a video.

### BACKGROUND

An electronic device and a program are known which are capable of editing acquired still-image data or acquired video-image data. For example, Patent Literature (PTL) 1 discloses a video-contents editing apparatus which can edit, on an arbitrary frame basis, a video on which inter-frame coding has been performed on a group of pictures (GOP) basis, and can associate editing information with the video so as to administrate the editing information.

### CITATION LIST

### Patent Literature

[PTL 1] Japanese unexamined patent application publication No. 2009-260933

### SUMMARY

### Technical Problem

For a user who wants to edit a video easily, it is beneficial that the video editing can be performed in a shorter time.

The present disclosure provides an image processing device capable of performing the video editing more efficiently.

### Solution to Problem

An image processing device according to the present disclosure includes a processor that: (i) acquires video data including a plurality of frames, and characteristic information indicating a characteristic value of an image in each of the frames; (ii) receives designation of a correction-target frame which is one of the frames; (iii) identifies, as a correction section, a section to which a frame group belongs, based on the characteristic information, the frame group being made up of consecutive frames including the correction-target frame; and (iv) applies correction designated by a user to the frame group which belongs to the identified correction section.

### Advantageous Effects

An image processing device according to the present disclosure can perform the video editing more efficiently.

### BRIEF DESCRIPTION OF DRAWINGS

These and other objects, advantages and features of the invention will become apparent from the following description thereof taken in conjunction with the accompanying drawings that illustrate a specific embodiment of the present invention.

FIG. 1 is a diagram which shows a primary hardware configuration of a digital video camera according to an embodiment.

FIG. 2 is a diagram which shows a primary hardware configuration of a personal computer (PC) according to the embodiment.

FIG. 3 is a block diagram which shows a primary functional configuration of the PC according to the embodiment.

FIG. 4 is a flowchart which illustrates an operational flow of a digital video camera according to the embodiment.

FIG. 5 is a diagram which shows metadata generated during recording of a video in the digital video camera according to the embodiment.

FIG. 6 is a diagram which shows a configuration of an editing screen of an image editing application according to the embodiment.

FIG. 7 is a flowchart which illustrates a basic-processing flow in relation to correction processing in the PC according to the embodiment.

FIG. 8 is a flowchart which illustrates a specific processing flow in relation to the correction processing in the PC according to the embodiment.

FIG. 9 is a flowchart which illustrates a coding flow in the PC according to the embodiment.

FIG. 10 is a block diagram which shows a functional configuration in the PC according to the embodiment, in relation to coding processing in a corrected section.

### DESCRIPTION OF EMBODIMENT

Hereinafter, an embodiment is described in detail, arbitrarily referring to the drawings. Detailed description beyond the necessity may be omitted. For example, detailed description for well-known matter or duplicated description for a configuration substantially same with those previously described may be omitted. This is to avoid the following description from being unnecessarily redundant, and to help a person skilled in the art to easily comprehend the description.

It should be noted that the inventor provides the attached drawings and the following description for a person skilled in the art to adequately comprehend the present disclosure. It is not intended that the drawings and the description limit a subject matter of the claims.

### Embodiment

<1-1. Outline>

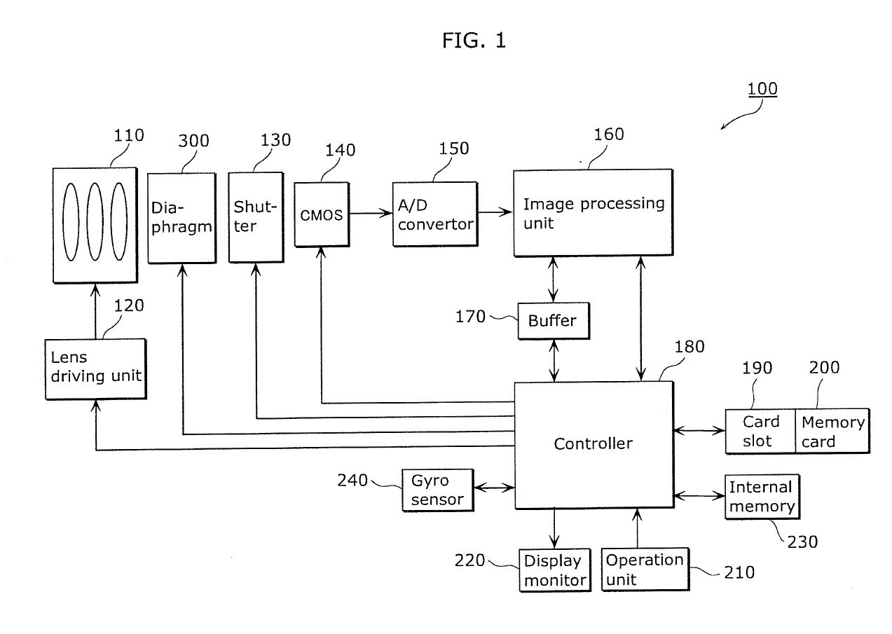

FIG. 1 is a diagram which shows a primary hardware configuration of a digital video camera 100 according to an embodiment.

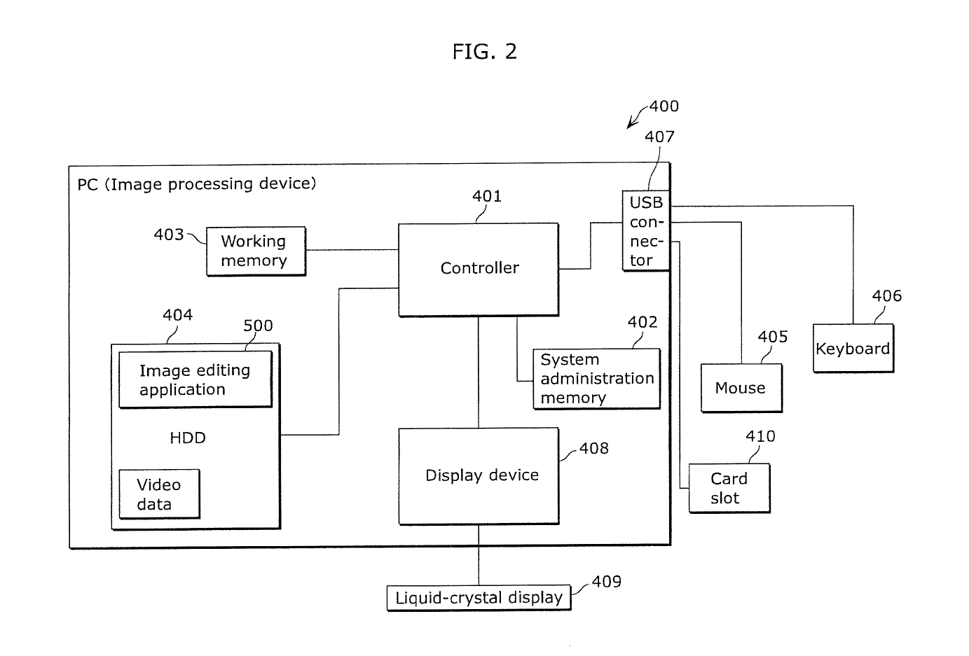

FIG. 2 is a diagram which shows a primary hardware configuration of a personal computer (PC) 400 according to the embodiment.

The digital video camera 100 according to the embodiment records a shooting condition as metadata along with actual data of a video, when shooting the video.

The PC 400 according to the embodiment identifies a section which can be considered, for example, to be shot in the same shooting condition, from a single pictorial cut in the inputted video data. Then, the PC 400 collectively performs correction on the section which can be considered to be shot in the same shooting condition.

In the following description, the digital video camera 100 and the PC 400 according to the embodiment are described with respect to a configuration and an operation, referring to the drawings.

<1-2. Configuration>

<1-2-1. Configuration of Movie Camera>

A configuration of the digital video camera 100 according to the embodiment is described, with reference to FIG. 1.

In the digital video camera 100, a complementary metal-oxide semiconductor (CMOS) imaging sensor 140 captures a subject image formed by an optical system 110 which includes one or more lenses.

Image data generated by the CMOS image sensor 140 undergoes various processing by the image processing device 160, and is stored in a memory card 200.

The optical system 110 includes a zoom lens, a focus lens, and the like. The zoom lens is moved along an optical axis, thereby enlarging and reducing the subject image. The focusing lens is moved along the optical axis, thereby adjusting the focus on the subject image.

A lens driving unit 120 drives various lenses included in the optical system 110 to move. The lens driving unit 120 includes, for example, a zoom motor for driving the zoom lens and a focus motor for driving the focus lens.

A diaphragm 300 adjusts a size of an aperture automatically or in accordance with user setting, thereby adjusting an amount of light passing through the aperture of the diaphragm 300.

A shutter 130 blocks light reaching the CMOS image sensor 140 via the shutter 130.

The CMOS image sensor 140 captures a subject image formed in the optical system 110 to generate the image data. The CMOS image sensor 140 performs various operations, such as, exposure, transfer, an electronic shutter, and the like.

An analog-digital (A/D) converter 150 converts analog image data generated by the CMOS image sensor 140 to digital image data.

The image processing unit 160 performs various processing on the image data (more specifically, referring to the digital image data that has undergone conversion by the A/D converter, hereinafter) generated by the CMOS image sensor 140, generates image data to be displayed on a display monitor 220, generates image data to be stored in the memory card, and performs other processing. The image processing unit 160 performs various processing on the image data generated by the CMOS image sensor 140, such as gamma correction, white-balance correction, and defect correction.

In addition, the image processing unit 160 compresses, as video data, the image data generated by the CMOS image sensor 140, in complying with a compression format and the like based on H.264 standard or a moving picture experts group (MPEG) 2 standard.

The image processing unit 160 records, in a single frame basis, information of sensitivity obtained by the CMOS image sensor 140, information of shutter speed, a value (a white-balance value) used for the white-balance correction performed by the image processing unit 160, and so on, as metadata indicating the shooting condition (shooting information) with respect to the moving data which is being recorded.

It should be noted that the image processing unit 160 can be achieved using a digital signal processor (DSP) or a microcomputer.

The metadata is an example of characteristic information indicating a characteristic value for each of images in a plurality of frames. Each of the information for the sensitivity, the information for the shutter speed, and the white-balance value is an example of the characteristic value of an image.

The controller 180 controls the entirety of the digital video camera 100. The controller 180 can be achieved using a semiconductor element, and the like. The controller 180 may also be achieved using hardware alone or combination of hardware and software. The controller 180 can by achieved using a microcomputer, and the like.

A buffer 170 serves as a working memory of the image processing unit 160 and the controller 180. The buffer 170 can be implemented as, for example, a dynamic random access memory (DRAM), or a ferroelectric memory.

A card slot 190 is a device to/from which the memory card 200 is inserted/removed. Specifically, the card slot 190 is mechanically and electrically connectable to the memory card 200.

The memory card 200 includes therein a flash memory, ferroelectric memory, or the like, and can store the video data generated by the image processing unit 160, and the like.

An internal memory 230 includes a flash memory, a ferroelectric memory, or the like. The internal memory 230 stores a control program or the like for controlling the entirety of the digital video camera 100.

An operation unit 210 is a user interface for receiving an operation from a user. The operation unit 210 includes, for example, a video recording button, a cross key, a set button, and the like for receiving operations from a user.

When the digital video camera 100 is in a shooting mode, the controller 180 receives press of the video recording button, and starts recording the video data in the memory card 200. When receiving the press of the video recording button by the user during recording of the video, the controller 180 halts recording the video data in the memory card 200.

The display monitor 220 can display an image (a through image) indicated by the image data generated by the CMOS image sensor 140, and an image indicated by the image data read out from the memory card 200. The display monitor 220 can also display various menu screens and the like whereby various settings of the digital video camera 100 are made.

A gyro sensor 240 detects camera shake in a yawing direction and camera motion in a pitching direction based on an angle variation of the digital video camera 100 per unit time, i.e., an angular rate. The gyro sensor 240 outputs, to the controller 180, a gyro signal indicating an amount of the detected motion.

<1-2-2. PC Configuration>

The PC 400 is an example of image processing devices, and includes a controller 401, a system administration memory 402, a working memory 403, a hard disc drive (HDD) 404, a universal serial bus (USB) connector, and a display device 408. The controller 400 is connected to a mouse 405, a keyboard 406, a liquid-crystal display 409, and the like.

The controller 401 includes a processor, such as a central processing unit (CPU) or the like, and serves as a processing unit for causing various information in the PC 400 to be executed. The controller 401 is electrically connected to the system administration memory 402, the working memory 403, the HDD 404, the display device 408, and the USB connector 407.

The controller 401 can change screens displayed on the liquid-crystal display 409 via the display device 408. The controller 401 receives, via the USB connector 407, information regarding an operation of a user using the mouse 405 and the keyboard 406.

The controller 401 controls the entirety of a system (not shown), such as electric power supplied to each of units in the PC 400.

The system administration memory 402 is a memory in which an operating system (OS) or the like is stored. In the system administration memory 402, a system time and the like are also stored. The system time is updated by executing the program in the OS by the controller 401.

The working memory 403 is a memory for temporarily storing information necessary for the controller 401 to perform various processing. In the working memory 403, various information items are stored by the controller 401. The various information items includes, for example, shooting information of editing-target video data, correction information indicating various parameters adjusted by a user, information for defining a section (correction section) to which the correction is applied, and the like.

The various information items are described below which are stored in the working memory 403 when the PC 400 performs the editing processing on the video data.

The working memory 403 has the shooting information for each of frames, which is obtained from the metadata associated with the video data to be corrected (hereinafter, also referred to as “correction-target video data”). In other words, in the working memory 403, the shooting information for each of the frames is stored, which is the characteristic information contained in the correction-target video data.

The controller 401 can obtain and update the shooting information stored in the working memory 403.

The working memory 403 has a parameter for image correction which is required by a user, as the correction information. The parameter for the image correction includes a hue, chroma, brightness, luminance, contrast intensity, noise-reduction filter intensity, and the like. The controller 401 can obtain and update the correction information stored in the working memory 403.

The working memory 403 has information for defining the correction section, as correction section information. The controller 401 can obtain and update the correction section information stored in the working memory 403. The controller 401 can also obtain the correction section information from the working memory 403, and present, via the display device 408, a correction section on the liquid-crystal display 409, using a value indicated in the correction section information.

The HDD 404 is a disc drive which has a large capacity to store video data and the like. In addition, in the HDD 404, an execution file for an image-editing application program 500 (hereinafter, referred to as “image-editing application 500”) is stored.

The controller 401 loads, in the working memory 403, the execution file stored in the HDD 404, in accordance with an instruction by a user to start up the image-editing application 500. Accordingly, the controller 401 can perform various processing operations in accordance with the image-editing application 500.

The mouse 405 is a pointing device used by a user upon the editing operation. The user operates the mouse 405 so as to perform, on an editing screen of the image-editing application 500, selection and changing of the frames to be corrected (also referred to as “correction-target frame”, hereinafter), changing in the correction sections, adjustment of the parameters for various correction, and the like.

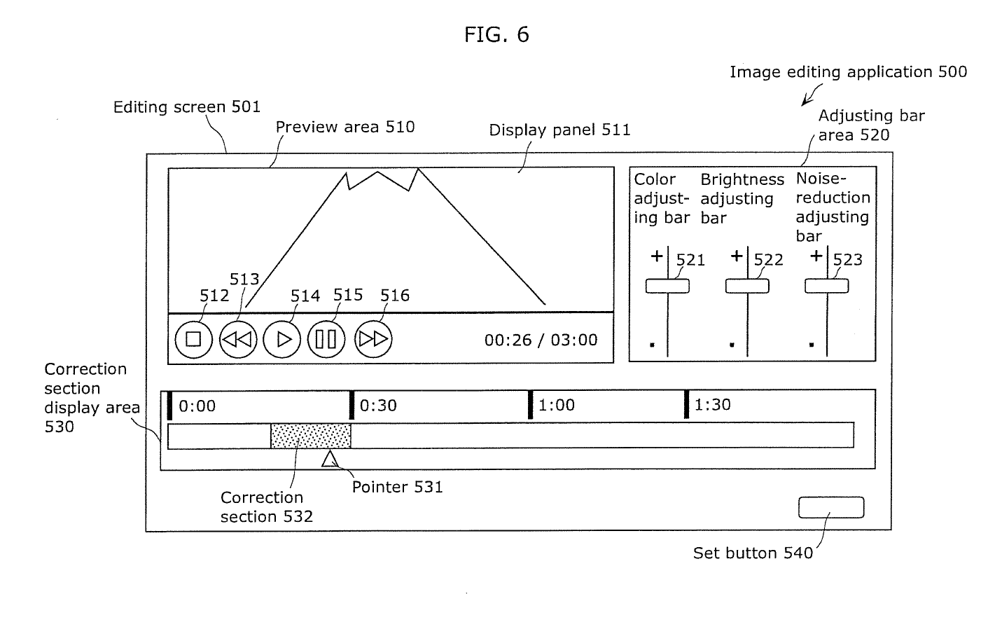

An example of configuration of the editing screen displayed on the liquid-crystal display 409 is described later, referring to FIG. 6.

The keyboard 406 is a keyboard device used by a user, upon the editing operation, for inputting character and the like to the PC 400.

The USB connector 407 is a connector for connecting the mouse 405, the keyboard 406, and the card slot 410 to the PC 400.

The card slot 410 is a device to/from which the card memory 200 is inserted/removed. Specifically, the card slot 410 can be mechanically and electrically connected to the memory card 200. The card slot 410 can also be electrically connected to the controller 401, via the USB connector 407. It should be noted that the card slot 410 is not limited to an external configuration which is to be used via the USB connector 407, but may be included in the PC 400.

The display device 408 is a device for imaging screen information calculated by the controller 401, and for transmitting the screen information to the liquid-crystal display 409.

The liquid-crystal display 409 is a display device for displaying the screen information imaged by the display device 408.

The controller 401 reads out the image-editing application 500 from the HDD 404, stores the read-out image-editing application 500 in the working memory 403, starts the image-editing application 500, and executes the image-editing application 500.

The controller 401 obtains the shooting information from the working memory 403, and identifies a point at which the shooting information changes, for example. The controller 401 identifies one or more frames containing the shooting information which can be considered, for example, to be same with that of the frame selected by a user as the correction-target frame in the video data. With the above, the section to which a frame group which includes a plurality of frames including the frame selected as the correction-target frame, is identified as a candidate of the correction section.

The controller 401 can further update the correction section information stored in the working memory 403, in accordance with the identified correction section.

The controller 401 can also update the correction section information stored in the working memory 403, in accordance with the correction section adjusted by the operation by the user.

The controller 401 can obtain the correction information from the working memory 403, and perform the image processing (correction) on the frame obtained by decoding the correction-target video data using a value contained in the correction information.

The controller 401 reads out the correction-target video data which is stored in the HDD 404 so as to perform the decoding, perform the image processing on the decoded video data, codes the video data on which the image processing has been performed, and stores the coded video data in the HDD 404 as an output file

The controller 401 can also extract a motion vector, an intra prediction mode, and the like, from the video data during a process of the decoding, and perform a part of the processed in the decoding at high speed, using the extracted motion vector, the intra prediction mode, and the like.

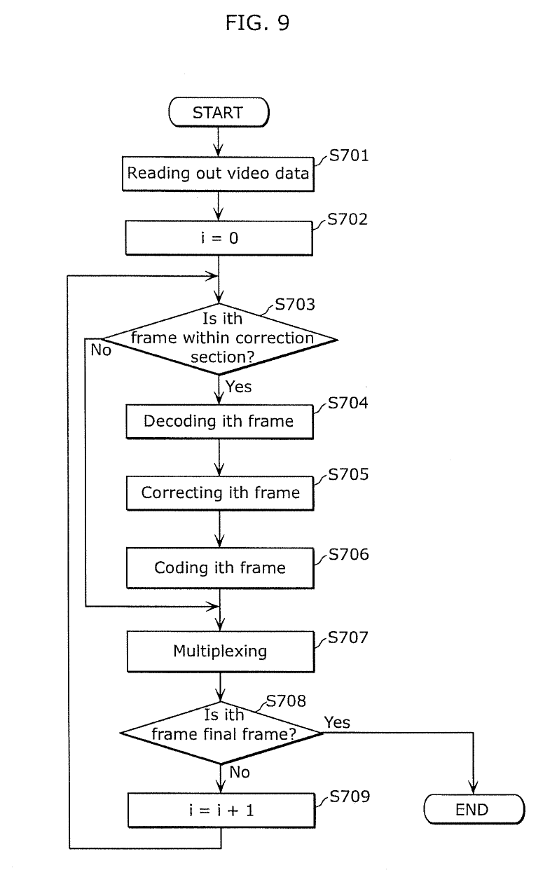

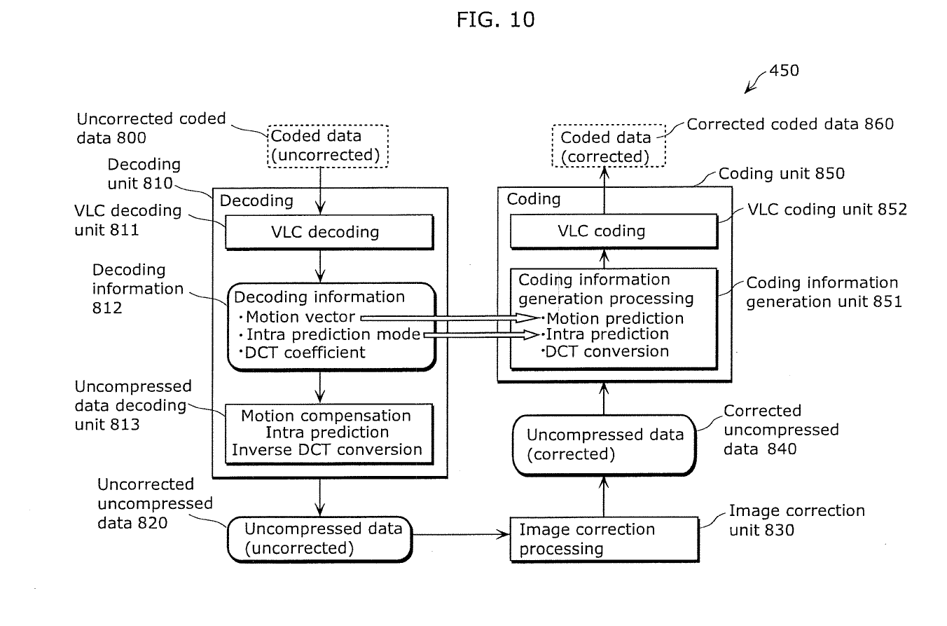

A specific flow of a series of processes in each of the decoding, correction, and coding, which are performed by the controller 401, is described later, with reference to FIGS. 9 and 10.

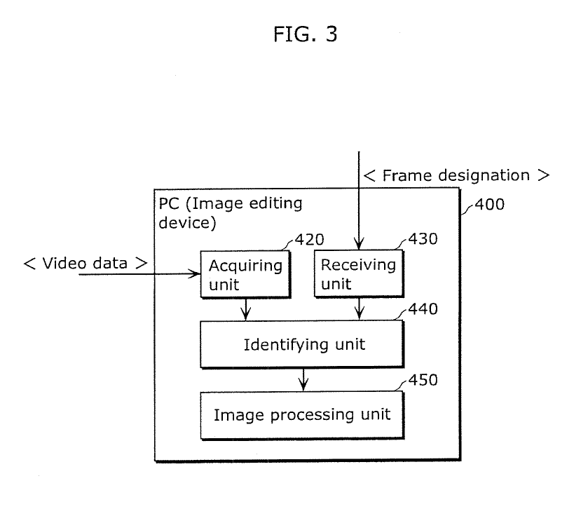

Next, a functional configuration of the PC 400 according to the embodiment is described, referring to FIG. 3.

FIG. 3 is a block diagram which shows a primary functional configuration of the PC 400 according to the embodiment.

As shown in FIG. 3, the PC 400 according to the embodiment includes, as primary functional units, an acquiring unit 420, a receiving unit 430, an identifying unit 440, and an image processing unit 450.

It should be noted that below-described processing performed by each of the acquiring unit 420, the receiving unit 430, the identifying unit 440, and the image processing unit 450 is achieved by executing the aforementioned image-editing application 500 and the like by the controller 401, in the present embodiment.

The acquiring unit 420 acquires the video data including a plurality of frames, and the characteristic information indicating a characteristic value of an image of each of the frames.

In the present embodiment, the acquiring unit 420 (controller 401) acquires, via the memory card 200, the video data which is generated by the digital video camera 100 and contains the metadata indicating the shooting information for each of the frames.

The receiving unit 430 receives designation of the correction-target frame which is one of the frames.

In the present embodiment, the receiving unit 430 (controller 401) receives, via the USB connector 407, the designation on the correction-target frame, inputted in the PC 400 in response to an operation of the mouse 405 or the keyboard 406.

The identifying unit 440 identifies, as the correction section, a section to which the frame group made up of consecutive frames including the correction-target frame belongs, based on the characteristic information.

In the present embodiment, the identifying unit 440 (controller 401) identifies the correction section, based on the characteristic value (the white-balance value and the like indicated in the shooting information) indicated in the metadata of the correction-target frame.

The image processing unit 450 applies the correction designated by a user to the frame group which belongs to the correction section identified by the identifying unit 440.

In the present embodiment, the image processing unit 450 (controller 401) performs the correction on the frame group which belongs to the correction section, in accordance with a type of the correction, a parameter, and the like, which are set by a user operating the mouse 405 or the keyboard 406.

Specifically, upon the correction, the decoding and the coding are performed by the image processing unit 405 (controller 401), as mentioned above.

When the phrase “correction is applied to a frame” is used, in the present embodiment, it should be appreciated that the PC 400 which serves as the image processing device performs the correction processing on the image indicated in the frame.

The “correction” or “correction processing” to be applied to a frame includes processing of changing in the hue, chroma, brightness, luminance, color temperature, color tone, or contrast, or processing of removing noise. Briefly, “correction” or “correction processing” is the image processing without substantial change in arrangement in a whole image. The image processing includes lightening of an image in the frame, changing in colors of the image, preventing from roughness in the image, and the like.

Therefore, “correction” or “correction processing” can also be referred to as, for example, the changing in the image quality shown in the frame.

<1-3. Operation>

<1-3-1. Recording Operation by Digital Video Camera>

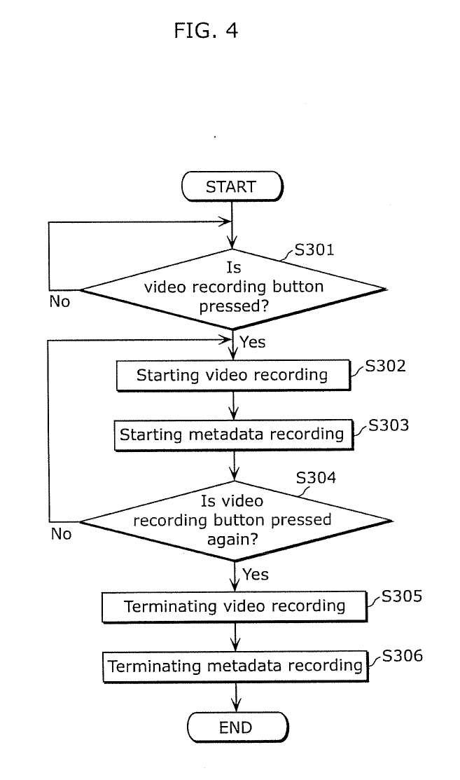

Subsequently, a recording operation by the digital video camera 100 is described, with reference to FIG. 4.

FIG. 4 is a flowchart which illustrates an operational flow of the digital video camera 100 in the present embodiment.

The controller 180 determines whether or not a video recording button is pressed (Step S301). When the video recording button is pressed (Yes in Step S301), the controller 180 starts recording video data in the memory card 200 (Step S302).

The controller 180 starts recording the video data and also starts recording metadata in the memory card 200 (Step S303).

The metadata is data describing, for each of the frames of the video data to be generated, shooting information at the time when the frame is generated. For example, in the video data recorded with 60 frames per second (fps), the metadata in which 60 sets of shooting information are described as the shooting information for 1 second is recorded.

The controller 180 determines whether or not the video recording button is pressed again (Step S304). If the video recording button is pressed again (Yes in Step S304), the controller 180 terminates the recording of the video, and also terminates the recording of the metadata (Steps S305 and S306).

If the video recording button is not pressed again (No in Step S304), the controller 180 continues the recording of the video data (Step S302) and the recording of the metadata (Step S303).

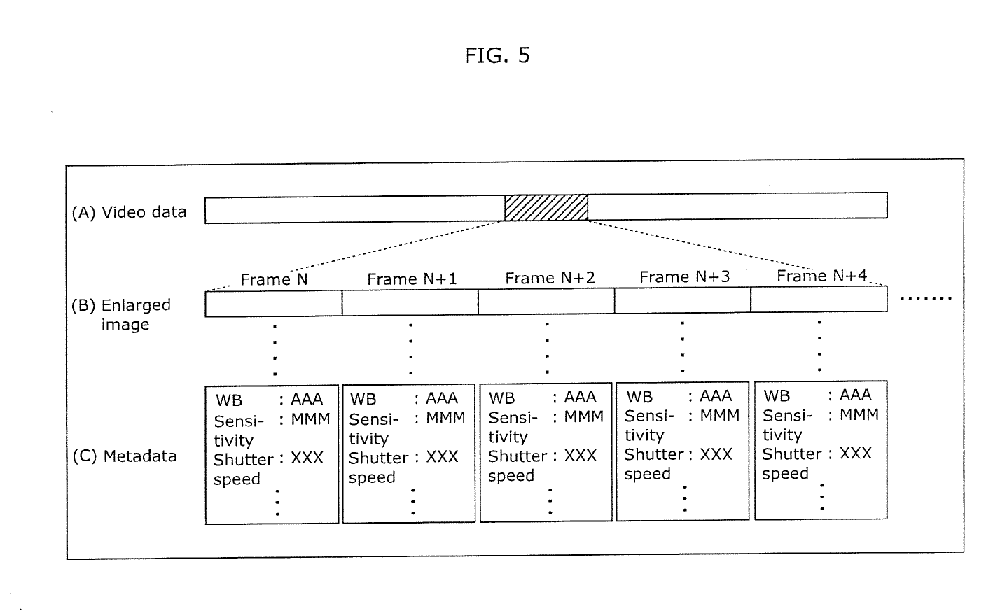

FIG. 5 is a diagram which shows the metadata generated during recording of a video, in the digital video camera 100 according to the embodiment.

FIG. 5 (A) is a diagram which shows the entirety of the video data generated by the digital video camera 100. FIG. 5(B) is a diagram which shows a plurality of frames serving as a part of the video data shown in the FIG. 5(A). FIG. 5(C) is a diagram which shows the metadata in which the shooting condition corresponding to each of the frames shown in FIG. 5(B).

The metadata is associated with the video data in such a manner that one set of the metadata corresponds to one frame of the video data. For example, the metadata corresponding to a frame is recorded in the header of the frame in the video data. In one set of the metadata, various values are recorded which include the white-balance value, the value for the sensitivity, the value indicating the shutter speed, and the like.

<1-3-2. Determination on Correction Section by PC>

Subsequently, an identifying operation by the PC 400 to identify correction section is described. First, a preparation operation for image editing is described.

As described above, the card slot 410 can be inserted by the memory card 200 in which video data containing metadata is recorded by the digital video camera 100. When the memory card 200 is inserted in the card slot 410, the controller 401 detects a state that the memory card 200 is mounted.

When the controller 401 detects the memory card 200, a user can make a copy of the video data recorded in the memory card 200 to the HDD 404 in the PC 400, using the mouse 405, and the like.

With this, the video data recorded in accordance with the flowchart illustrated in FIG. 4 is recorded in the HDD 404 in the PC 400. In other words, in the HDD 404, the metadata which corresponds to the frame and is included in the header of each of the frame, is recorded along with actual data of each of the frames in the video data.

When an execution file for executing the image-editing application 500 is selected by a user using the mouse 405 and the like, the controller 401 executes and starts up the image-editing application 500. The controller 41 starts up the image-editing application 500, and then, displays a screen (editing screen) of the image-editing application on the liquid-crystal display 409.

FIG. 6 is a diagram which shows a configuration of an image screen 501 of the image-editing application 500 according to the embodiment.

The editing screen 501 includes a preview area 510, an adjusting bar area 520, a correction-section display area 530, a set button 540, and the like.

The preview area 510 includes a display panel 511 for displaying a content of the video data, a stop button 512, a review button 513, a play button 514, a pause button 515, a fast-forward button 516.

A user can look for a frame to be corrected in the video data by selecting the stop button 512, the review button 513, the play button 514, the pause button 515, and the fast-forward button 516, using the mouse 405 and the like. The user can also check the corrected video on the display panel 511.

For example, if a user presses the play button 514 using the mouse 405, the controller 401 reads out the video data to be corrected from the HDD 404 and performs decoding. Then, the controller 401 continuously displays, via the display device 408, each of the frames forming the video data resulting from the decoding, on a position of the display panel 511 on the liquid-crystal display 409. With the above, the video data to be corrected is played.

When a user presses the pause button 515 using the mouse 405, the controller 401 displays, via the display device 408, only one frame among a plurality of frames forming the video data resulting from the decoding, on the position of the display panel 511 on the liquid-crystal display 409. Accordingly, the one frame displayed on the display panel 511 is selected as the correction-target frame.

As described above, a user can look for a frame to be corrected in the video data by selecting the stop button 512, the review button 513, the play button 514, the pause button 515, and the fast-forward button 516, using the mouse 405 and the like.

According to the present embodiment, the adjusting bar area 520 includes a color adjusting bar 521, a brightness adjusting bar 522, and a noise-reduction intensity bar 523. Thus, a user can correct an image as he/she likes.

The controller 401 reads out the correction information stored in the working memory 403, and plots a value of each of the parameters indicated in the correction information on position information of each of the adjusting bars. With this, the color adjusting bar 521, the brightness adjusting bar 522, and the noise-reduction intensity bar 523 are displayed in the respective positions according to the correction information, in the adjusting bar area 520 on the liquid-crystal display 409.

For example, each of the adjusting bars is positioned at ±0 in a default position. In other words, the correction information stored in the working memory 403 for the occasion is stated in such a manner that an adjusted value of each of the color, brightness, noise-reduction is ±0.

A case is supposed that a user change a position of any one of the color adjusting bar 521, the brightness adjusting bar 522, and the noise-removal intensity bar 523, using the mouse 405. In this case, the controller 401 performs the image processing on the frame resulting from the decoding and is displayed on the display panel 511, in accordance with the correction information complying with the positions of the changed adjusting bars. Then, the controller 401 displays, via the display device 408, the result of the image processing on the position of the display panel 511 on the liquid-crystal display 409.

In other words, if the user changes the positions of the respective adjusting bars using the mouse 405, a preview of a frame which reflects the result of the adjustment is displayed on the display panel 511 in real time. Therefore, the user can easily figure out whether or not a desired result of the adjustment is obtained.

In the correction section display area 530, timeline information of the video data to be edited (also referred to as “editing-target video data”, hereinafter) is displayed. In the correction section display area 530, also displayed are a bar indicating the entire section of the editing-target video data, and a time point counted from the start of the recording with respect to the bar indicating the entire section.

The correction section display area 530 includes a pointer 531, a correction section 532, and the like. The pointer 531 indicates a position of the frame currently displayed on the display panel 511 with respect to the entire section of the video data. Accordingly, the position of the correction-target frame in the entire video data is indicated by the pointer 531.

With the above, a user can easily figure out which point the frame currently displayed (correction-target frame) positions in the entire section of the video data.

The correction section 532 indicates to which area the correction adjusted using the adjusting bar area 520 is applied, in the entire section of the video data.

This allows the user to easily check which area the correction selected and adjusted by the user himself/herself is applied to in the entire section of the video data. In addition, the user can adjust a length of the correction section by dragging at least one of the left and right ends of the presented correction section 532 using the mouse 405.

The controller 401 reads out the correction information stored in the working memory 403, and plots the read-out information to temporal position information of the correction section display area 530. The controller 401 further presents, via the display device 408, the temporal position information in the correction section display area 530 on the liquid-crystal display 409, as the correction section 532.

In addition, when a user drags at least one of the left and right ends of the presented correction section 532 using the mouse 405, the controller 401 plots the temporal position information on the correction section information, so as to update the correction section information stored in the working memory 403 using the plotted temporal position information as new correction section information.

In other words, when receiving an instruction to make a change on the specified correction section 532, the controller 401 updates the correction section 532 in response to the change instruction.

When the user presses the set button 540 using the mouse 405, the controller 401 reads out the correction section information and the correction information which are stored in the working memory 403, and performs processing for outputting a file resulting from the correction, and stores the result of the outputting (i.e., the corrected video data) in the HDD 404.

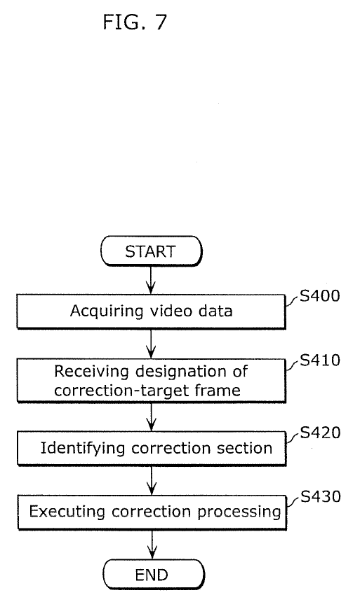

Next, a flow of basic processing in relation to the correction processing performed by the PC 400 is described, with reference to FIG. 7.

FIG. 7 is a flowchart which illustrates a flow of the basic processing in relation to the correction processing performed by the PC 400 according to the embodiment.

To be specific, FIG. 7 shows the basic processing performed in each of the functional blocks (see FIG. 3 which shows the acquiring unit 420, the receiving unit 430, the identifying unit 440, and the image processing unit 450) achieved using the controller 401 according to the embodiment.

The acquiring unit 420 acquires the video data including a plurality of frames, and the characteristic information metadata indicating a characteristic value of an image of each of the frames (Step S400).

The receiving unit 430 receives designation of a correction-target frame which is one of the frames (Step S410).

The identifying unit 440 identifies, as the correction section, a section to which the frame group made up of consecutive frames including the correction-target frame belongs, based on the characteristic information (Step S420).

The image processing unit 450 applies the correction designated by a user to the frame group which belongs to the correction section identified by the identifying unit 440 (Step S430).

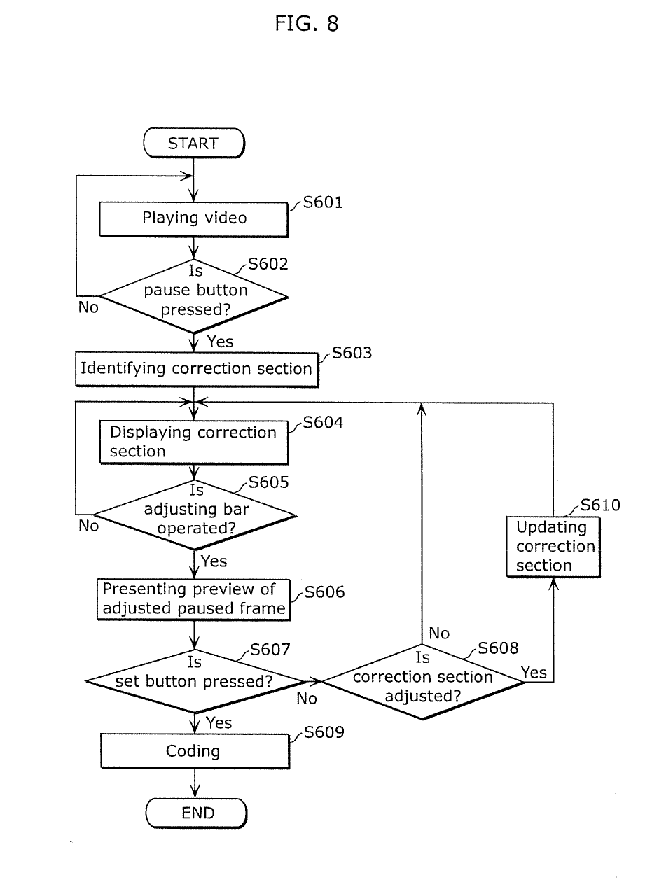

Subsequently, a flow of specific processing in relation to the correction processing performed by the PC 400 is described, with reference to FIG. 8.

FIG. 8 is a flowchart which illustrates a flow of the specific processing in relation to the correction processing performed by the PC 400 according to the embodiment.

The controller 401 reads out the correction-target video data from the HDD 404, performs decoding, and display the decoded correction-target video data on the display panel 511. With the above, the correction-target video data is played (Step S601).

The controller 401 determines whether or not the pause button 515 is pressed (Step S602). If the pause button is not pressed (No in Step S602), the controller 401 continues to play the correction-target video data. If the controller 401 determines the pause button 515 is pressed (Yes in Step S602), the controller 401 identifies the correction section (Step S603).

Upon identifying the correction section, the controller 401 first reads out the metadata corresponding to the frame (correction-target frame) displayed on the display panel 511 from among the metadata (see FIG. 5(C)) of each of the frames, which is stored in the working memory 403.

The controller 401 then scans the metadata of the frame positioned in temporarily forward (the left in FIG. 5) of the correction-target frame.

The controller 401 identifies one ore more frames each having metadata indicating a parameter which can be considered as the same with the parameter (for example, at least one of a white-balance value, a sensitivity value, and a shutter-speed value) indicated by the metadata of the correction-target frame.

The controller 401 identifies one or more frames each having the metadata which shows the parameter indicating, for example, a value smaller than or equal to a predetermined threshold value, as a difference from the parameter shown by the metadata of the correction-target frame.

As the result of scanning the metadata of the frame positioned temporally forward of the correction-target frame, the controller 401 identifies a frame corresponding to a parameter which cannot be considered to be the same with the parameter indicated by the metadata of the correction-target frame. The controller 401 further sets a start position of the frame which is temporally one frame after the identified frame, as the left end (start position of the correction) of the correction section 532.

Subsequently, the controller 401 starts scanning the metadata of each of the frames positioned temporally backward (in the right in FIG. 5) of the correction-target frame.

The controller 401 identifies one ore more frames each having metadata indicating the parameter which can be considered to be the same with the parameter indicated by the metadata of the correction-target frame. As the result of scanning the metadata of the frame positioned temporally backward from the correction-target frame, the controller 401 identifies a frame corresponding to a parameter which cannot be considered to be the same with the parameter indicated by the metadata of the correction-target frame. The controller 401 further sets an end position of the frame which is temporally one frame before the identified frame, as the right end (correction end position) of the correction section 532.

In other words, the controller 401 according to the present embodiment identifies one or more frames positioned in at least one of temporally forward and backward of the correction-target frame. Each of the one or more frames has the characteristic value within a predetermined range from the characteristic value of the correction-target frame. With this, the controller 401 identifies the correction section 532 which a frame group including the correction-target frame as well as the aforementioned one or more frames belong to.

The controller 401 plots, on the timeline, a time range of the identified correction section 532, thereby presenting an image showing the correction section 532, in the correction section display area 530 (Step S604).

Then, the controller 401 determines whether or not any one of adjusting bars including the color adjusting bar 521, the brightness adjusting bar 522, and the noise-reduction intensity bar 523 is operated by a user (Step S605).

If none of the color adjusting bar 521, the brightness adjusting bar 522, and the noise-reduction intensity bar 523 is operated (No in Step S605), the controller 401 maintains the display of the frame (correction-target frame) which is paused, on the display panel 511.

On the other hand, if any one of the color adjusting bar 521, the brightness adjusting bar 522, and the noise-reduction intensity bar 523 is operated (Yes in Step S605), the controller 401 performs the image processing (correction) on the correction-target frame resulting from the decoding displayed on the display panel 511, in accordance with the correction information complying with the positions of the respective adjusting bars. The controller 401 further displays, via the display device 408, the image resulting from the image processing, in a position of the display panel 511 on the liquid-crystal display 409 (Step S606).

The controller 401 determines whether or not the set button 540 is pressed (Step S607). If the set button 540 is not pressed (No in Step S607), the controller 401 determines whether or not the change of the correction section 532 is instructed (Step S608).

When determining the change of the correction section 532 is not instructed (No in Step S608), the controller 401 continues the presenting processing (Step S604) without changing the start and end positions of the correction indicated in the correction section 532.

On the other hand, when determining the change of the correction section 532 is instructed (Yes in Step S608), the controller 401 changes the correction section information (Step S610) which defines the correction section 532, and performs the presenting processing on the correction section 532 in accordance with the changed correction section information (Step S604).

When determining the set button is pressed in Step S607 (Yes in Step S607), the controller 401 performs coding of the video data (Step S609).

Specifically, the controller 401 performs the image processing on the frame group which belongs to the correction section 532, in accordance with the correction information complying with the positions of the respective adjusting bars in the adjusting bar area 520. Then, the controller 401 codes data resulting from the image processing, and stores the coded data in the HDD 404. With the above, the corrected video data can be obtained.

<1-3-3. PC Operation of Outputting Corrected File>

Subsequently, the coding (Step S609) is described in detail. To be specific, the coding performed at the time when the corrected video data is outputted is described in detail, with reference to FIG. 9.

FIG. 9 is a flowchart which illustrates a flow of coding performed by the PC 400 according to the embodiment.

The controller 401 reads out the correction-target video data from the HDD 404 (Step S701). Then, a counter i indicating a frame position is initialized with zero (Step S702).

The controller 401 reads out the video data by one frame, and determines whether or not the read-out ith frame is included in the correction section 532 (the section between the correction start position and the correction end position) (Step S703).

When determining the ith frame is included in the correction section 532 (Yes in Step S703), the controller 401 decodes the ith frame (Step S704). Subsequently, the controller 401 performs the image processing on the decoded ith frame, in accordance with the correction information complying with the positions of the respective adjusting bars in the adjusting bar area 520, and obtains an uncompressed frame which is the corrected ith frame (Step S705).

The controller 401 further performs coding on the obtained uncompressed frame, and obtains the coded data corresponding to the ith frame (Step S706). Then, the processing proceeds to multiplexing in Step S707.

In the multiplexing (Step S707), the coded data obtained in Step S706 and audio data associated with the coded data are multiplexed. The audio data has been, for example, separated from the video data and held in the processing in Step S701.

On the other hand, when determining the ith frame is not included in the correction section 532 (No in Step S703), the controller 401 does not perform the image processing on the read-out ith frame, in accordance with the correction information complying with the positions of the respective adjusting bars in the adjusting bar area 520, and treats the read-out frame as the ith coded data. Then the controller 401 shifts the processing to the multiplexing in Step S707.

The controller 401 performs the multiplexing on the ith coded data to which the correction is not applied (Step S707), and stores the multiplexed ith coded data in the HDD 404, as a part of the video data resulting from the correction (Step S707).

Subsequently, the controller 401 determines whether or not the ith frame is the last frame of the correction-target video data (Step S708). When determining the ith frame is the last frame of the correction-target video data (Yes in Step S708), the controller 401 terminates the coding, and treats the video data which is the result of the correction and is stored in the HDD 404 in the multiplexing (Step S707), as the video data obtained as the final result of the correction.

When determining the ith frame is not the last frame of the correction-target video data (No in Step S708), the controller 401 increments the frame counter i, and continues the processing in Steps S703 to S708.

Here, a method for performing, in short time, processing in steps (Steps S704 to S706 shown in FIG. 9) of the decoding, correcting, and coding on the ith frame is described, with reference to FIG. 10.

FIG. 10 is a block diagram which shows a functional configuration included in the image processing unit 450 according to the embodiment, in relation to the coding of the correction section.

As shown in FIG. 10, the image processing unit 450 included in the PC 400 includes a decoding unit 810, an image correction unit 830, and a coding unit 850.

The decoding unit 810, the image correction unit 830, and the coding unit 850 are achieved using the controller 401 in the present embodiment.

The decoding in Step S704 corresponds to a part of the processing shown in FIG. 10, in which uncorrected coded-data 800 is decoded in the decoding unit 810, and uncorrected uncompressed-data 820 is obtained.

The coding in Step S706 corresponds to another part of the processing shown in FIG. 10, in which corrected uncompressed-data 840 is coded in the coding unit 850, and corrected coded-data 860 is obtained.

As shown in FIG. 10, the decoding unit 810 includes a variable-length-coding (VLC) decoding unit 811 and an uncompressed-data decoding unit 813. The decoding unit 810 receives the uncorrected coded-data 800 as input data, and outputs the uncorrected uncompressed-data 820.

In the decoding unit 810, the VLC decoding unit 811 performs VLC decoding on the inputted uncorrected coded-data 800, and outputs decoded information 812.

The decoding information 812 per a processing unit, such as a macroblock, includes a motion vector or an intra prediction mode, a discrete cosine transformation (DCT) coefficient, and the like.

The controller 401 stores the decoding information 812 obtained by the VLC decoding, in the working memory 403, for example. Subsequently, the uncompressed data decoding unit 813 reads out the decoding information 812 from the working memory 403, performs processing of motion compensation, intra-screen prediction, and inverse DCT transformation, using the read-out decoding information 812, and outputs the obtained uncorrected uncompressed-data 820.

The image correction unit 830 receives the uncorrected uncompressed-data 820 as input data, and outputs the corrected uncompressed-data 840. The image correction unit 830 performs image processing on the processing target frame (uncorrected uncompressed-data 820), in accordance with the correction information complying with the positions of the respective adjusting bars in the adjusting bar area 520.

As shown in FIG. 10, the coding unit 850 includes the coding information generation unit 851 and the VLC coding unit 852. The decoding unit 850 receives the corrected uncompressed-data 840 as input data, and outputs the corrected coded-data 860.

In the coding unit 850, the coding information generation unit 851 performs, on the inputted corrected uncompressed-data 840, one of the motion prediction processing and the intra screen prediction processing, and the DCT conversion processing, on a per processing unit basis, such as the macroblock, and generates information necessary for the VLC coding.

When the motion prediction processing is performed, the coding unit 850 reads out a motion vector corresponding to the processing target data from the decoding information 812 stored in the working memory 403, and sets the motion vector as the motion vector of the corrected coded-data.

When the intra screen prediction processing is performed, the coding unit 850 reads out an intra prediction mode corresponding to the processing target data from the decoding information 812 stored in the working memory 403, and sets the intra prediction mode as the intra prediction mode of the corrected coded-data.

Then, the VLC coding unit 852 performs the VLC coding on the information generated by the coding information generation unit 851, and outputs the corrected coded-data 860 obtained by the VLC coding.

As described above, the image processing unit 450 (controller 401) uses the motion vector and the intra prediction mode which are obtained from the uncorrected coded-data, for generating the corrected coded-data. Accordingly, the corrected coded-data can be generated in a short time.

Here, the correction processing performed by the PC 400 according to the present embodiment is image processing, such as the lightening of an image in a frame, that is, processing unaccompanied with any change in a configuration in the entire image.

Accordingly, information obtained by the decoding of correction-target coded-data can be used for coding the corrected uncompressed-data 840. The information includes the motion vector, the intra prediction mode, or the like, by a processing unit, such as the macroblock.

In other words, the corrected coded-data can be obtained as data in which the DCT coefficient is changed, while the motion vector or the intra prediction mode in the uncorrected coded-data is maintained.

As described above, with the PC 400 according to the present embodiment, generation of the corrected coded-data is speeded up.

<1-4. Advantageous Effects>

As described above, the PC 400 according to the present embodiment includes the acquiring unit 420, the receiving unit 430, the identifying unit 440, and the image processing unit 450.

The acquiring unit 420 acquires the video data including a plurality of frames, and metadata indicating the characteristic value of an image in each of the frames.

The receiving unit 430 receives designation of a correction-target frame, which is one of the frames.

The identifying unit 440 identifies, as a correction section, a section to which a frame group made up of consecutive frames including the correction-target frame belongs, based on the metadata.

The image processing unit 450 applies the correction designated by a user to the frame group which belongs to the correction section.

In the present embodiment, the PC 400 includes the controller 401 (processor) which serves as the acquiring unit 420, the receiving unit 430, the identifying unit 440, and the image processing unit 450.

In other words, an image editing device (PC 400) includes a processor that: (i) acquires video data including a plurality of frames, and metadata indicating a characteristic value of an image in each of the frames; (ii) receives designation of a correction-target frame which is one of the frames; (iii) identifies, as a correction section, a section to which a frame group belongs, based on the metadata, the frame group being made up of consecutive frames including the correction-target frame; and (iv) applies correction designated by a user to the frame group which belongs to the identified correction section.

The PC 400 includes the above configuration, thereby automatically identifying, as the correction section, the section to which a frame group belongs. The frame group is, for example, associated with the shooting condition (shooting information) which can be considered as the same with that of the correction-target frame. As a result, the PC 400 can perform, at once, the correction processing on the frame group which belongs to the correction section, so as to perform the video editing in a shorter time.

In the present embodiment, the processor identifies one or more frames positioned in at least one of temporally forward and backward of the correction-target frame, to thereby identify the correction section to which the frame group including the correction-target frame and the one or more frames belongs, the one or more frames each having a characteristic value within a predetermined range from a characteristic value of the correction-target frame.

With this configuration, the frame group is identified which has a shutter speed within a predetermined range from a standard value as the characteristic value (shooting information). The standard value is defined by the shutter speed of the correction-target frame. As a result, the frame group is identified which has brightness (or darkness) approximately same with that of the correction-target frame. In other words, the correction section is identified to which the frame group having frames suitable for the application of the same correction belongs.

In the present embodiment, the processor identifies the correction section using a value which (i) is indicated in the metadata, (ii) serves as the characteristic value of the image in each of the frames, and (iii) indicates a shooting condition for generating the video data.

In the present embodiment, the processor applies, to each of the frames in the frame group, the correction which is processing for changing at least one of a hue, chroma, brightness, luminance, a contrast intensity, and a noise-reduction filter intensity.

With this configuration, the PC 400 can apply various corrections according to a request of a user to the frame group in the correction section identified by the PC 400.

In the present embodiment, the processor further receives an instruction to make a change on the identified correction section, and updates the correction section in accordance with the change instruction. The processor further applies the correction to the frame group which belongs to the updated correction section.

With this configuration, the correction section automatically identified by the PC 400 can be changed according to the determination of a user, for example.

In the present embodiment, the processor: outputs (i) uncompressed data which corresponds to the frame group, and is obtained by decoding coded data which is data of the frame group belonging to the correction section, and (ii) decoding information which indicates one of a motion vector and an intra prediction mode which are obtained by the decoding.

The processor applies the correction to the uncompressed data obtained by the decoding. The processor performs coding on the uncompressed data to which the correction is applied, using one of the motion vector or the intra prediction mode which are indicated in the decoding information.

With this configuration, the PC 400 can reduce calculation load required for the coding associated with the image correction, thereby performing video editing in a shorter time.

### Another Embodiment

As described above, the embodiment has been described as an example of the technique disclosed in the present application. However, the technique in the present disclosure is not limited to the above embodiment, and is applicable to an embodiment to which modification, replacement, addition, omission, and the like are appropriately conducted. It is also possible to create a new embodiment by combining structural components described in the above embodiments.

Another embodiment is exemplified hereinafter.

In the above embodiment, the shooting condition is recorded in metadata for each frame from start to end of video shooting. However, if the frame rate is 60 fps, a representative value of the shooting condition may be recorded every 60 frames

At this time, the representative value may be an average value of values indicated in the shooting condition (for example, the white-balance value) in the 60 frames, alternatively, may be a value of the first frame or the last frame of the 60 frames. The representative value may also be a value of a middle frame in the 60 frames.

Accordingly, a data format of the characteristic information (metadata in the embodiment) used by the PC 400 for identifying the correction section has no limitation, as long as each of the frames and a value treated as the characteristic value of the image in each of the frames are associated with each other.

In the present embodiment, the controller 401 (processor) identifies the correction section with reference to at least one of the white-balance value, the sensitive value, and the shutter speed value which are indicated by the metadata of the correction-target frame.

Therefore, the controller 401 (processor) may identify the correction section, using two or more types of characteristic values.

For example, the controller 401 may identify the correction section by identifying one or more frames each having the white-balance value within a predetermined range from the white-balance value indicated in the metadata of the correction-target frame, and also having the shutter speed value within a predetermined range from the shutter speed value indicated in the metadata.

Upon identifying one or more frames each having the characteristic value within a predetermined range from the characteristic value (standard characteristic value) of the correction-target frame, the determination whether or not the characteristic value is within the predetermined range may not be performed on a basis of whether or not difference between the standard characteristic value and the characteristic value to be compared is smaller than or equal to a threshold value. For example, when the ratio of a comparison-target characteristic value with respect to the standard characteristic value is within a previously set range (for example, 90% to 110%, and so on), it may be determined that the comparison-target characteristic value is within a predetermined range from the standard characteristic value.

For example, when a change ratio (change amount per unit time) of the comparison-target characteristic value with respect to the standard characteristic value is within a predetermined set range, it may be determined that the comparison-target characteristic value is within a predetermined range from the standard characteristic value.

The predetermined range for the determination may not be a fixed range, but may be changeable by a user, for example. For example, the predetermined range is narrowed, thereby performing determination more strictly as to whether or not the correction-target frame belongs to the frame group to which the same correction performed on each of the frames should be applied at once.

The correction section may be identified by identifying one or more frames each associated with the characteristic value coincident with the standard characteristic value.

In other words, the correction section may be identified based on the characteristic information (metadata in the embodiment) indicating the characteristic value of the image in each of the frames included in the video data. Various methods can be adopted as a method, using the characteristic value (standard characteristic value) of the correction-target frame, for identifying the frame to be included in the correction section.

In the present embodiment, a value indicating the shooting condition, such as the white-balance value, and the like is exemplified, as the characteristic value of the image in each of the frames included in the video data. However, the characteristic value of the image in each of the frames may be another type of value.

For example, an average pixel value of the frame may be treated as the characteristic value of the frame. In addition, if a video frame to be corrected is video data to which some correction has already been applied, a parameter used for the correction may be adopted as the characteristic value for identifying the correction section in the video data.

The characteristic value indicated in the characteristic information used for identifying the correction section need not be a numerical value. A character or a symbol indicating the characteristic of the image may be treated as the characteristic value.

In other words, any values may be adopted as the characteristic value of each of the frames, as long as the value identifies the frame group in which the frames can be considered to have approximately same brightness, darkness, roughness and the like in appearance.

In the present embodiment, metadata which is an example of the characteristic information is included in the video data. However, the video data and the characteristic information may be acquired by the PC 400 as mutually separated data. Accordingly, the PC 400 may acquire the video data and the characteristic information separately from each other, as long as correction-target video data and characteristic information corresponding to the video data are associated with each other.

The PC 400 may also acquire the video data and the characteristic information without using the memory card 200. The PC 400 may, for example, acquire the video data and the characteristic information from the digital video camera 100, using a wired or wireless communication network.

The content of the correction (type of the correction, the value of the parameter, and the like) designated by a user in the PC 400 may not be determined by a user's direct instruction. For example, if a user designates “automatic correction”, the PC 400 may execute the image editing application 500, thereby allowing correction to be performed. The correction is such that the content thereof is previously set, or is set by analyzing the frame group in the correction section by the PC 400.

The effect (speeding-up of the generation of the corrected coded-data) obtained by a series of processing performed by the image processing unit 450, described referring to FIG. 10, is exerted even when the correction is performed on the entire video data. The effect is also exerted when the correction is performed on the frame group in the correction section identified by a user, for example.

The image processing unit 450 in the PC 400 can also be achieved as an image processing device which applies the correction on the one or more frames in the video data.

Accordingly, the image processing device is an image processing device which performs correction on video data including a plurality of frames. The image processing device includes the decoding unit 810, the image correction unit 830, and the coding unit 850.

The decoding unit 810 outputs uncompressed data corresponding to a frame group obtained by decoding the coded data serving as data of the frame group which belongs to the designated correction section and is included in the frames, and decoding information indicating a motion vector or an intra prediction mode.

The image correction unit 830 applies the correction having the content designated by the user to the uncompressed data obtained by the decoding.

The coding unit 850 performs coding on the uncompressed data to which the correction is applied, using one of the motion vector and the intra prediction mode which are indicated in the decoding information.

A part of or all of functions of units included in the image processing device may be achieved using a single or a plurality of integrated circuits. The units include the decoding unit 810, the image correction unit 830, and the coding unit 850. In other words, the image processing device may be achieved by combination of dedicated circuits.

The image processing device includes the above configuration, so as to perform the coding on the corrected data, using one of the motion vector and the intra prediction mode which are obtained by the decoding performed before the correction. As a result, the generation of the corrected coded-data can be performed in a shorter time.

A part or all of functions of the units included in the PC 400 (see FIG. 3) according to the embodiment may be achieved using a single or a plurality of integrated circuits. The units include the acquiring unit 420, the receiving unit 430, the identifying unit 440, and the image processing unit 450. Accordingly, the image editing device according to the present embodiment may be achieved using combination of dedicated circuits.

In the present embodiment, the PC 400 as an example of the image editing device is described with respect to a configuration and a processing flow thereof. However, another type of electronic device may be functioned as the image editing device.

For example, a server computer (hereinafter, referred to as “server”) connected to the Internet may be functioned as the image processing device. A controller executing information processing in the server functions as, for example, the acquiring unit 420, the receiving unit 430, the identifying unit 440, and the image processing unit 450, so that the server can perform the aforementioned processing, such as identifying the correction section, generating the video data to which the correction is applied, and the like.

In this case, a user can upload video stream from a local PC to the server via the Internet, for example, and remotely perform the editing such as designation of the correction-target frame. As a result of the editing, the video data to which the correction is applied can be downloaded to the PC.

An electronic device, such as a mobile terminal, a video camera, and a video recorder may be functioned as the image editing device according to the present disclosure. For example, the digital video camera 100 shown in FIG. 1 may include the acquiring unit 420, the receiving unit 430, the identifying unit 440, and the image processing unit 450.

In other words, an image processing method including processing executed by the image processing device (PC 400) according to the embodiment may be executed by various electronic devices.

In addition, an image processing method including a series of processing in relation to image correction associated with decoding and coding, described referring to FIGS. 9 and 10, may be executed by various electronic devices.

As described above, the embodiment is described as an example of the technique disclosed in the present disclosure. For the disclosure, the attached drawings and the detailed description are provided.

Accordingly, structural components illustrated in the attached drawings and described in the detailed disclosure may include not only necessary structural components but also structural components that are not essential for solving the problems, in order to exemplify the above technique. Therefore, the illustration or description of these inessential structural components in the attached drawings and the detailed description should not lead immediate recognition on the necessity of the inessential structural components.

The above described embodiments should be referred to as an example of the technique of the present disclosure. Accordingly, various modification, replacement, addition, omission, and the like can be performed within the scope of the claims and the equivalents thereof.

Although only some exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

### INDUSTRIAL APPLICABILITY

The present disclosure is applicable to an image processing device which can perform video editing more efficiently. To be specific, the present disclosure is applicable to an electronic device, such as a PC, a server, a mobile terminal, a video camera, a video recorder, and so on. In addition, the present disclosure is also applicable to a recording medium, such as a compact disc (CD) or a digital versatile disc (DVD) which stores a program capable of causing a PC to execute functions similar with those executed by the electronic devices.

1. An image processing device comprising
a processor that:
(i) acquires video data including a plurality of frames, and characteristic information indicating a characteristic value of an image in each of the frames;
(ii) receives designation of a correction-target frame which is one of the frames;
(iii) identifies, as a correction section, a section to which a frame group belongs, based on the characteristic information, the frame group being made up of consecutive frames including the correction-target frame; and
(iv) applies correction designated by a user to the frame group which belongs to the identified correction section.

2. The image processing device according to claim 1,
wherein the processor identifies one or more frames positioned in at least one of temporally forward and backward of the correction-target frame, to thereby identify the correction section to which the frame group including the correction-target frame and the one or more frames belongs, the one or more frames each having a characteristic value within a predetermined range from a characteristic value of the correction-target frame.

3. The image processing device according to claim 1,
wherein the processor identifies the correction section using a value which (i) is indicated in the characteristic information, (ii) serves as the characteristic value of the image in each of the frames, and (iii) indicates a shooting condition for generating the video data.

4. The image processing device according to claim 1,
wherein the processor applies, to each of the frames in the frame group, the correction which is processing for changing at least one of a hue, chroma, brightness, luminance, a contrast intensity, and a noise-reduction filter intensity.

5. The image processing device according to claim 1,
wherein the processor further:
receives an instruction to make a change on the identified correction section;
updates the correction section in accordance with the change instruction; and
applies the correction to the frame group which belongs to the updated correction section.

6. The image processing device according to claim 1,
wherein the processor:
outputs (i) uncompressed data which corresponds to the frame group, and is obtained by decoding coded data which is data of the frame group belonging to the correction section, and (ii) decoding information which indicates one of a motion vector and an intra prediction mode which are obtained by the decoding;
applies the correction to the uncompressed data obtained by the decoding; and
coding the uncompressed data resulting from the applied correction, using one of the motion vector and the intra prediction mode which are indicated in the decoding information.

7. An integrated circuit comprising
a processor that:
(i) acquires video data including a plurality of frames, and characteristic information indicating a characteristic value of an image in each of the frames;
(ii) receives designation of a correction-target frame which is one of the frames;
(iii) identifies, as a correction section, a section to which a frame group belongs, based on the characteristic information, the frame group being made up of consecutive frames including the correction-target frame, and
(iv) applies correction designated by a user to the frame group which belongs to the identified correction section.

8. An image processing method comprising:
acquiring video data including a plurality of frames and characteristic information indicating a characteristic value of an image in each of the frames;
receiving designation of a correction-target frame which is one of the frames;
identifying, as a correction section, a section to which a frame group belongs, based on the characteristic information, the frame group being made up of consecutive frames including the correction-target frame; and
applying correction designated by a user to the frame group which belongs to the correction section identified in the identifying.
